(19) United States
(12) Patent Application Publication
(10) Pub. No.: US 2019/0029422 A1
(43) Pub. Date: Jan. 31, 2019

(54) Furniture Base Assembly For Non-free Standing Furniture

(71) Applicant: Robert David Lacroix, II, Brookfield, CT (US)

(72) Inventor: Robert David Lacroix, II, Brookfield, CT (US)

(21) Appl. No.: 15/856,788

(22) Filed: Dec. 28, 2017

(51) Int. Cl. A47B 91/00; B60B 33/00; A47B 91/12

(52) U.S. Cl. CPC A47B 91/005; A47B 91/12; B60B 33/0015

(57) ABSTRACT

A weighted base assembly with casters and/or glides and an attached column assembly to create a furniture base assembly (FBA) that accepts and holds a leg of the non-free standing furniture to create an independent stable support system for that piece of furniture so that it becomes free standing, and also moveable while being held by the FBA(s).

It is the object of this invention to provide a furniture base assembly (FBA) for each leg on a piece of non-free standing furniture that holds the piece upright and independent of any other support, and also allows the piece to be moved while held by the FBA(s).

This gives the user the option to simply place the non-free standing furniture into the FBA(s) then move the piece anywhere they desire without leaning it on, or securing it to, a vertical surface for support.

Accordingly, the invention consists of a weighted base assembly with casters and/or glides and an attached column assembly to create a FBA that accepts and holds a leg of the non-free standing furniture to create an independent stable support system for that piece of furniture so that it becomes free standing, and also moveable while being held by the FBA(s).

It will be apparent that the FBA can be manufactured from natural, manmade, or a combination of both materials; and can include: designs, scents, fragrances, coatings, layers and components.

### BACKGROUND OF THE INVENTION

Non-free standing furniture is usually secured to or placed against a vertical surface to both orient it and support it for use and safety.

In order to move the non-free standing furniture it must unsecured, moved then resecured in its new location; or moved then placed against a new vertical surface.

An issue arises when there is no suitable mounting location for the non-free standing furniture, such as limited wall space; or the attachment points of piece do not engage with the attachment points of the mounting location.

The level of inconvenience and expense incurred by the user can vary from not being able to place the non-free standing furniture in the user's preferred location, to modification of the piece and/or mounting location, to substitution of the piece with another piece of furniture.

For users' that move and/or showcase furniture frequently both the inconvenience and the expense can be significant, while for other users modification can cause permanent damage to the piece of furniture.

### SUMMARY OF THE INVENTION

It is the object of this invention to provide a FBA for each leg on a piece of non-free standing furniture that holds the piece upright and independent of any other support, and also allows the piece to be moved while held by the FBA(s).

This gives the user the option to simply place the non-free standing furniture into the appropriate number of FBA(s) then move the piece anywhere they desire without leaning it on, or securing it to, a vertical surface for support.

Accordingly, the invention consists of a weighted base assembly with casters and/or glides and an attached column assembly to create a FBA that accepts and holds a leg of the non-free standing furniture to create an independent stable support system for that piece of furniture so that it becomes free standing, and also moveable while being held by the FBA(s).

### BRIEF DESCRIPTION OF THE DRAWINGS

One embodiment of the invention will now be described, with references to the accompanying drawings, in which:

FIG. 1 is an assembled view showing a non-free standing furniture leg installed in the FBA;

FIG. 2 is a cross sectional view of fastening locations on the column assembly and the base assembly with installed glides; and

FIG. 3 is an exploded view of the column assembly and base assembly with casters oriented to be fastened together.

### DETAILED DESCRIPTION OF THE PREFERRED EMBODIMENTS

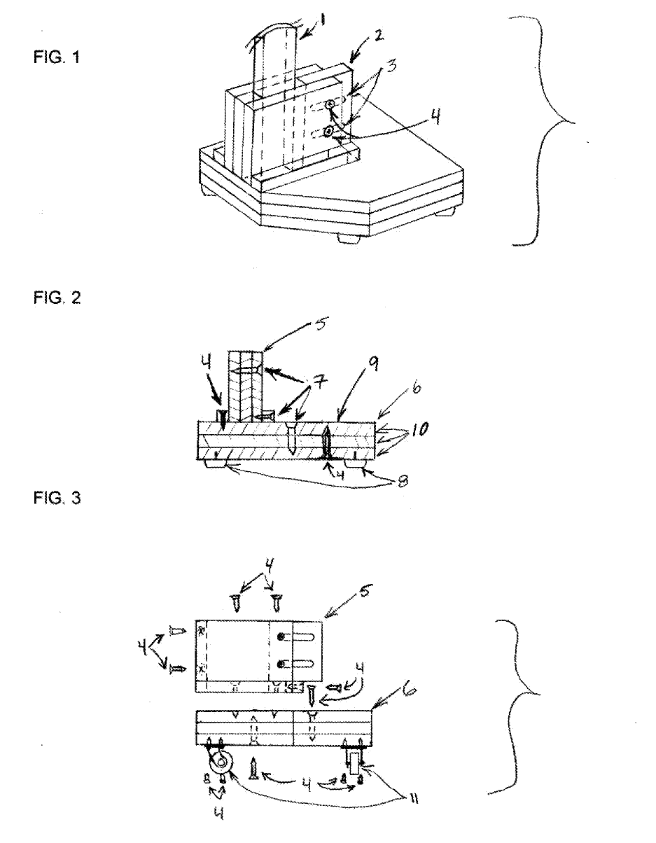

In FIG. 1 the FBA has a leg 1 of a piece of non-free standing furniture installed. Leg 1 is secured in place by cleat 2 that has slots 3 which allows it to be positioned along the vertical surface of leg 1 and tightened by fasteners 4 securing leg 1 to the FBA.

FIG. 2 shows typical fastening locations 5 for the column assembly 6, the base assembly 7 and to fasten the column assembly 6 to the base assembly 7. The base assembly 7 also shows glides 8 mounted to it. All of the fasteners 4 are removable so that the column assembly 6 can be located anywhere on the horizontal facing surface 9 of the base assembly 7. The base assembly 7 has a multilayer 10 design to accommodate various density materials adjust its center of gravity, and also make it reversible. The base assembly's horizontal facing surface 9 allows for additional layer(s) to be placed on it to further adjust its center of gravity to aid in the support of the non-free standing furniture.

FIG. 3 shows the column components to be assembled together with fasteners 4 creating the column assembly 6. The base components are also shown ready for assembly with fasteners 4 creating the base assembly 7 with casters 11. The column assembly 6 is orientated for assembly with fasteners 4 to the base assembly 7 to create the FBA.

The foregoing describes only one preferred embodiment of the invention and modifications can be made thereto without departing from the scope of the invention.

I claim:

1. A furniture base assembly (FBA) for each leg on a piece of non-free standing furniture that holds the piece upright and independent of any other support, converting the piece to free standing furniture that can be also moved while held by the FBA(s).

2. The FBA as claimed in claim 1 can be manufactured from natural, manmade, or a combination of both materials; and can include: designs, scents, fragrances, coatings, layers and components.

3. An adjustable cleat through the use of mounting slots to secure the leg of non-free standing furniture in the column portion of the FBA.
